(19) United States
(12) Patent Application Publication
(10) Pub. No.: US 2012/0125846 A1
(43) Pub. Date: May 24, 2012

(54) FILTERING METHOD, AND MEMBRANE-FILTERING APPARATUS

(75) Inventors: Keitaro Suzumura, Chiyoda-ku (JP); Takashi Tsukahara, Chiyoda-ku (JP)

(73) Assignee: ASAHI KASEI CHEMICALS CORPORATION, Tokyo (JP)

(21) Appl. No.: 13/379,919

(22) PCT Filed: Jun. 26, 2009
(86) PCT No.: PCT/JP2009/061753

§ 371 Date: Feb. 14, 2012

(51) Int. Cl. C02F 1/00

(52) U.S. Cl. 210/637; 210/96.2

(57) ABSTRACT

A filtration method for filtering raw water to obtain permeate by performing a filtration operation using pressure as a driving force for membrane modules, wherein the filtration operation is performed in three modes: raw water side pressure filtration, permeate side negative pressure filtration, and composite filtration combining the raw water side pressure filtration and the permeate side negative pressure filtration, any one of raw water side water quality, membrane filtration flux and transmembrane pressure is measured, and any one of the three filtration modes is switched to another in response to a measured value thereof.

### TECHNICAL FIELD

The present invention relates to a filtration method and membrane filtration apparatus filtering with a membrane module using pressure as a driving force to treat clean water, an industrial water supply, river water, lake water, ground water, reservoir water, secondary treated sewage effluent, sewage, drainage and the like.

### BACKGROUND ART

There are two types of membrane filtration: 1) filtration by positive pressure on the raw water side of membrane and 2) filtration by negative pressure on the permeate side of membrane. Raw water side pressure filtration is a method in which the raw water side of a membrane is pressurized, and the permeate side is open under atmospheric pressure, to allow for filtering by producing a pressure differential (transmembrane pressure) between the raw water side of the member and the permeate side. On the other hand, the permeate side filtration under negative pressure is a method in which the raw water side of the membrane is open under atmospheric pressure, and the permeate side is under negative pressure to allow for filtering by producing a transmembrane pressure.

As raw water is filtered by the membrane in the above-mentioned method at a constant permeate flow rate, the suspended solids in the raw water or other substances larger than the sizes of membrane pores (hereinafter referred to as “membrane fouling substances”) are rejected causing concentration polarization or forming cake layers on the membrane (hereinafter referred to as “membrane fouling”) while simultaneously increasing filtration resistance, which eventually results in increased transmembrane pressure. Although chemical cleaning is required when the transmembrane pressure rises, it preferable that the frequency of chemical cleaning is reduced in consideration of operation costs and environmental load. Specifically, during continuous membrane filtration operation, it is preferable that a constant filtration flux is maintained over a long period of time, and that an increase in the transmembrane pressure difference is prevented.

As a means for preventing the rise of transmembrane pressure, a membrane treatment method is disclosed in Patent Document 1 in which treated liquid is circulated through intermembrane liquid passages with a circulation pump for membrane surface cleaning while liquid is sucked through the membrane with a suction pump in order to produce permeate.
Patent Document 1: Japanese Unexamined Patent Application Publication No. H11-300168

### DISCLOSURE OF THE INVENTION

### Problem to be Solved by the Invention

However, in a conventional membrane treatment method described in Patent Document 1, since the permeate extraction power depends on the suction power of a suction pump rather than on the pressure produced by a circulating pump, there are instances where the design filtration flux cannot be assured as a result of an increase in a transmembrane pressure caused by membrane fouling substances.

The present invention addresses the above-identified problems, and other problems associated with conventional methods and apparatuses, to provide a filtration method and membrane filtration apparatus capable of assuring designed membrane filtration fluxes, preventing an increase in the transmembrane pressure, and stably continuing a filtration operation over a long period of time.

### Means for Solving the Problem

In order to achieve the abovementioned objectives, the present invention provides:

(1) a filtration method for filtering raw water to obtain permeate by performing a filtration operation using pressure as a driving force for membrane modules, in which the filtration operation is performed in three modes: raw water side pressure filtration, permeate side negative pressure filtration and composite filtration combining the raw water side pressure filtration and the permeate side negative pressure filtration, any one of raw water side water quality, membrane filtration flux and transmembrane pressure is measured, and any one of the three filtration modes is switched to another in response to a measured value thereof;

(2) the filtration method according the abovementioned (1), in which the measured value is a characteristic value X indicating a concentration of a membrane fouling substance calculated from the raw water side water quality, the raw water side pressure filtration is conducted when the characteristic value X falls below a predetermined threshold value, and the raw water side pressure filtration switches to the composite filtration when the characteristic value X rises above a predetermined threshold value;

(3) the filtration method according the abovementioned (2), in which the characteristic value X is calculated from at least one selected from raw water side turbidity A (NTU) and raw water side total organic carbon content (mg/L);

(4) the filtration method according the abovementioned (3), in which the characteristic value X is calculated by X=A+B, when raw water side turbidity is A (NTU) and raw water side total organic carbon content is B (mg/L);

(5) the filtration method according the abovementioned (1), in which the measured value is the membrane filtration flux, and the permeate side negative pressure filtration is switched to the raw water side pressure filtration or the composite filtration when the measured value drops below a predetermined membrane filtration flux during constant flow rate filtration operation at the design flow rate via the said permeate side negative pressure;

(6) the filtration method according the abovementioned (1), in which the measured value is the suction lift of the permeate side corresponding to the transmembrane pressure, and the permeate side negative pressure filtration is switched to the raw water side pressure filtration or the composite filtration when the suction lift of the permeate side has reached the available NPSH during constant flow rate filtration operation at the design flow rate via the said permeate side negative pressure;

(7) the filtration method according to any of the above-mentioned (1) to (6), in which the said filtration operation is alternated with backwash operation, in which liquid runs through the membrane module from the permeate side to the raw water side with membrane air scrubbing being performed simultaneously;

(8) the filtration method according to the abovementioned (7), in which pressure is applied to the permeate side to perform backwash operation;

(9) the filtration method according to the abovementioned (7), in which negative pressure is applied to the raw water side to perform backwash operation;

(10) the filtration method according to the abovementioned (7), in which both positive pressure and negative pressure are applied to the permeate side and raw water side respectively to perform backwash operation;

(11) the filtration method according to the abovementioned (7), in which backwash may be performed by selectable means: applying positive pressure to the permeates side, applying negative pressure to the raw water side, or employing a combination of applying positive pressure to the permeates side and applying negative pressure to the raw water side.

(12) a membrane filtration apparatus provided with membrane modules using pressure as a driving force, comprising: a first means for regulating the raw water side pressure of membrane modules; a second means for regulating the permeate side pressure of the membrane modules; a measuring means for measuring the water quality of the raw water side of the membrane modules; and a controlling means for controlling at least one of the first pressure regulation means and the second pressure regulation means based on values measured by the said measuring means, in which mode switching takes place among three modes: raw water side pressure filtration, permeate side negative pressure filtration and composite filtration combining the raw water side pressure filtration and the permeate side negative pressure filtration;

(13) the membrane filtration apparatus according to the abovementioned (12), in which the second pressure regulation means is a vacuum pump, and the measuring means is at least a turbidimeter or a TOC analyzer; and

(14) the membrane filtration apparatus according to the abovementioned (12) or (13), in which the said controlling means selectively performs backwash by controlling at least one of the means that regulate the pressures on both the raw water and permeate sides, in order to perform backwash using the positive pressure on the permeate side, the negative pressure on the raw water side, or a combination of both pressures.

### Effect of the Invention

According to the present invention, a designed membrane filtration flux may be assured as is, an increase in the transmembrane pressure difference may be prevented, and filtration operation may be stably continued over a long period of time.

### BRIEF DESCRIPTION OF THE DRAWINGS

FIG. 1 is a typical system flow diagram showing the schematic structure of a membrane filtration apparatus capable of switching between raw water side pressure filtration, permeate side negative pressure filtration, and composite filtration, according to an embodiment of the present invention;

FIG. 2 is a typical system flow diagram showing the flow of a liquid during raw water side pressure filtration by the membrane filtration apparatus according to the present embodiment;

FIG. 3 is a typical system flow diagram showing the flow of a liquid during permeate side negative pressure filtration or composite filtration by the membrane filtration apparatus according to the present embodiment;

FIG. 4 is a typical system flow diagram showing the liquid flow in a cleaning process in which backwash by the positive pressure on the permeate side and air scrubbing are performed simultaneously;

FIG. 5 is a typical system flow diagram showing the liquid flow in a cleaning process in which backwash by the negative pressure on the raw water side and air scrubbing are performed simultaneously;

FIG. 6 is a typical system flow diagram showing the liquid flow in a liquid discharge process in which the membrane fouling substances removed from the membrane of a membrane module are discharged from the module;

FIG. 7 is a diagram showing the characteristic variation in the transmembrane pressure difference of Example 1, Comparative Example 1, and Comparative Example 2;

FIG. 8 is a diagram showing the characteristic variation in the turbidity of Example 1, Comparative Example 1, and Comparative Example 2;

FIG. 9 is a diagram showing the characteristic variation in the membrane filtration flux of Example 1, Comparative Example 1, and Comparative Example 2;

FIG. 10 is a diagram showing the characteristic variation in the transmembrane pressure difference of Example 2, and Comparative Example 3;

FIG. 11 is a diagram showing the characteristic variation in the transmembrane pressure difference of Example 3, Comparative Example 4, and Comparative Example 5;

FIG. 12 is a diagram showing a characteristic variation in the membrane filtration flux of Example 3, Comparative Example 4, and Comparative Example 5;

FIG. 13 is a diagram showing a characteristic variation in the transmembrane pressure difference of Example 4, Comparative Example 6, and Comparative Example 7; and

FIG. 14 is a diagram showing a characteristic variation in the membrane filtration flux of Example 4, Comparative Example 6, and Comparative Example 7.

### EXPLANATION OF THE REFERENCE NUMERALS

1: Raw water; 3: Pressure regulating filtration pump (second regulation device); 4: Membrane module; 5: Depressurizing filtration pump (first regulation device); 11: Water quality analyzer (measuring device); 40: Control unit (control device); 50: Membrane filtration apparatus.

### Best Configuration of Invention Embodiment

Hereinafter, embodiments of a membrane filtration apparatus according to the present invention will be described in detail with reference to the Drawings.

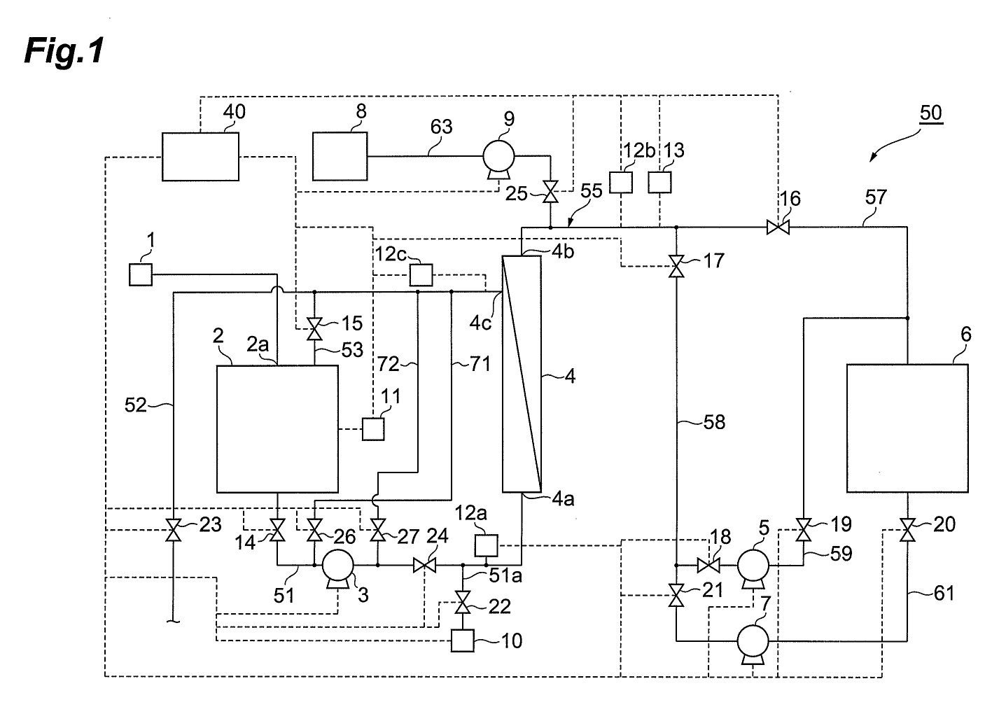

As shown in FIG. 1, a filtration apparatus 50 according to the present embodiment provides a membrane module 4, in which a solid-liquid separation membrane (hereinafter, referred to as “membrane”) is stored within a case. The filtration apparatus 50 is equipment for obtaining permeate by rejecting suspended solids in raw water 1 and other substances larger than the size of the fine pores of the membrane via a membrane module 4 using pressure as a driving force.

The membrane according to the present embodiment is a polyvinylidene fluoride (PVDF) hollow-fiber micro-filtration (MF) membrane with an inner diameter of 0.7 mm, an outer diameter of 1.2 mm, and an average pore size of 0.1 μm, and membrane module 4's effective surface area obtained from its outer surface area is 7.4 m². Moreover, the membrane module 4 is of outside-in filtration type having a polyvinyl chloride (PVC) housing with a length of 1 m and a diameter of 84 mm.

There is no particular restriction on membrane materials for the Invention. For example, membranes for the invention may be created using one of or mixtures of: polyolefins such as polyethylene, polypropylene, and polybutene; fluorinated resins such as tetrafluoroethylene-perfluoroalkyl vinyl ether copolymer (PFA), tetrafluoroethylene-hexafluoropropylene copolymer (FEP), tetrafluoroethylene-hexafluoropropylene-perfluoroalkyl vinyl ether copolymer (EPE), an ethylene-tetrafluoroethylene copolymer (ETFE), polychlorotrifluoroethylene (PCTFE), an ethylene-chlorotrifluoroethylene copolymer (ECTFE), and polyvinylidene fluoride (PVDF); a super engineering plastic such as a polysulfone, a polyether sulfone, a polyether ketone, a polyether ether ketone, and a polyphenylene sulfide; a cellulose such as cellulose acetate, and ethyl cellulose; polyacrylnitrile; and polyvinyl alcohol.

Furthermore, such membranes may be of any type such as hollow-fiber membrane, flat membrane, pleat-shaped membrane, spiral membrane, and tubular membrane. Hollow fiber membrane is particularly preferable because of its high backwash effect.

In addition, as the membrane module according to the present embodiment, preferable types are such that both ends or one end of a hollow fiber bundle is bonded, with both module end faces or one module end face open. In addition, the cross sectional shape of the bonded end(s) may be triangular, rectangular, hexagonal, elliptical as well as being circular. Membrane module 4 is a reference example of embodying the present invention.

Moreover, the membrane filtration apparatus 50 is provided with a raw water tank 2 for receiving the raw water 1, a permeate tank 6 for storing the permeate produced by the membrane module 4, a raw water supply pipeline 51 connecting the raw water tank 2 and inlet 4a of the membrane module 4, and a raw water circulating pipe 53 for returning drainage from drainage side outlet 4c of the membrane module to the raw water tank 2.

Pressure regulating filtration pump 3 for pressure feeding the raw water 1 stored in the raw water tank 2 to the membrane module is disposed in the raw water inlet pipeline 51, and valves 14 and 24 are provided on the upstream and downstream sides of pressure regulating filtration pump 3, respectively. Air inlet pipe 51a is connected to between the membrane module 4 and the valve 24, which are located downstream of pressure regulating filtration pump 3. Air supply pipe 51a is connected to compressor 10 supplying air for air scrubbing of the membrane of the membrane module 4, and valve 22 is provided in air supply pipe 51a. Valve 23 for opening a pipeline at wastewater discharge is provided in wastewater discharging pipeline 52. Pressure regulating filtration pump 3 serves as a first means of regulating the raw water side pressure.

Furthermore, first backwash pipeline 71 and second backwash pipeline 72, in which backwash water flows to raw water circulating pipe 53, are connected to raw water side pipeline 51. The first backwash pipeline 71 and the second backwash pipeline 72 are for delivering wastewater sucked out of retentate outlet 4c of the membrane module 4 by pressure regulating filtration pump 3 to wastewater discharging pipeline 52, and valves 26 and 27, respectively, are provided on the first backwash pipeline 71 and the second backwash pipeline 72.

Opening 2a to receive raw water 1 is provided in raw water tank 2, and the raw water circulating pipe 53 communicating with retentate outlet 4c of the membrane module 4 is connected to raw water tank 2. Valve 15 is provided in the raw water circulating pipe 53. Moreover, water quality analyzer 11 for measuring the quality of the raw water is side provided on the raw water tank 2. The water quality analyzer 11 is at least a turbidimeter or a TOC analyzer. The water quality analyzer 11 is equivalent to a means of measuring the water quality of the raw water side.

In addition, the membrane filtration apparatus 50 is provided with a permeate pipeline 55 connecting permeate outlet 4b of membrane module 4 and permeate tank 6. The permeate pipeline 55 branches off in two directions, where one pipeline is first pipeline 57 feeding permeate to the permeate tank 6 without being pressurized, and the other is second pipeline 58 feeding permeate from the membrane module 4 into the permeate tank 6 by applying negative pressure. First pipeline 57 is provided with valve 16 close to the branch point, and second pipeline 58 is provided with valve 17 also close to the point. In addition, the membrane filtration apparatus 50 includes a raw water inlet pressure analyzer 12a disposed on the raw water inlet pipeline 51, a permeate side pressure analyzer 12b disposed on the permeate pipeline 55, a raw water outlet pressure analyzer 12c disposed on the raw water circulating pipeline 53, and a membrane filtration flux analyzer 13. The raw water inlet pressure analyzer 12a, the permeate side pressure analyzer 12b, and the raw water outlet pressure analyzer 12c are apparatuses for measuring the pressure at these respective positions, and the membrane filtration flux analyzer 13 is an apparatus for measuring the membrane filtration flux of permeate flowing within the first pipeline 57.

Moreover, when the pressure measured by the raw water inlet pressure analyzer 12a is Pi, the pressure measured by the raw water outlet pressure analyzer 12c is Pp, and the pressure measured by the permeate side pressure analyzer 12b is Po, the transmembrane pressure difference Pd is calculated via the below-mentioned formula.

Pd=(Pi+Po)/2−Pp (Formula)

The pipeline 58 branches in route into two directions, so that one side becomes a filtered side pipeline 59, and another side becomes a backwashing side pipeline 61. A depressurizing filtration pump 5 is provided on the filtered side pipeline 59, and valves 18 and 19, respectively, are provided on the upstream side and the downstream side so as to sandwich the depressurizing filtration pump 5 therebetween. In addition, a pressurized backwash pump 7 is provided on the backwashing side pipeline 61, and valves 20 and 21, are provided, respectively on an even further downstream side and upstream side of the pressurized backwash pump 7, based on the direction of flow of the backwash. The depressurizing filtration pump 5 is equivalent to the second pressure regulating device regulating the permeate side pressure.

In the present embodiment, pressure regulating pump 3 is installed on the raw water sides of membrane module 4 and depressurizing filtration pump 5 on the permeate side while connected in series allowing them to be turned on and off independently, which is a suitable configuration but can be replaced with other configurations.

Furthermore, the membrane filtration apparatus 50 includes an oxidizing agent tank 8 storing an oxidizing agent as a chemical solution, and a chemical solution supply pipeline 63 supplying the oxidizing agent stored in the oxidizing agent tank 8 to the membrane module 4. An oxidizing agent solution feed pump 9 is provided on the chemical solution supply pipeline 63, and a valve 25 is also provided even further on the downstream side than the oxidizing agent solution feed pump 9. The downstream end of the chemical solution supply pipeline 63 communicates with the permeate water pipeline 55 at a location that is even further on the upstream side than the branching point of the first pipeline 57 and the second pipeline 58.

In addition, the membrane filtration apparatus 50 includes a control unit 40 controlling the filtration of raw water 1 with the membrane module 4, and the backwash operation in which permeate is fed into the membrane module 4 and the air scrubbing of the membrane module 4 are simultaneously performed. The control unit 40 is connected so as to be able transmit/receive a control signal to/from each of pumps 3, 5, 7, 9 and compressor 10. Furthermore, the control unit 40 is connected so as to be able transmit/receive a control signal to/from each of valves 14, 15, 16, 17, 18, 19, 20, 21, 22, 24, 25, 26 and 27. In addition, the control unit 40 is connected so as to be able receive measurement value data relating to the water quality of the raw water 1 measured by the water quality analyzer 11, is connected so as to be able receive measurement value data relating to the transmembrane pressure difference measured by the raw water inlet pressure analyzer 12a, the permeate side pressure analyzer 12b, and the raw water outlet pressure analyzer 12c, and is further connected so as to be able receive measurement value data relating to the membrane filtration flux measured by the membrane filtration flux analyzer 13.

The control unit 40 consists of hardware components including CPU, RAM, and ROM for arithmetic processing and data storage. In addition, Control unit 40 has mechanisms such as an input device, for example, to input threshold values used for evaluating the concentration of membrane fouling substances calculated from raw water quality and to input preset permeate fluxes and available net positive suction head (NPSH) used for evaluating permeate fluxes, and a monitoring screen that displays various kinds of data.

The control unit 40 activates and stops each of the pumps 3, 5, 7, 9 and the compressor 10 by transmitting a control signal thereto. The control unit 40 also controls the opening and closing of each of valves 14, 15, 16, 17, 18, 19, 20, 21, 22, 24, 25, 26 and 27, by transmitting a control signal to each thereof. In addition, the control unit 40 monitors a measurement value relating to the water quality of the raw water 1 measured by the water quality analyzer 11, a measurement value relating the transmembrane pressure difference measured by the raw water inlet pressure analyzer 12a, the permeate side pressure analyzer 12b and the raw water outlet pressure analyzer 12c, and a measurement value relating to the membrane filtration flux measured by the membrane filtration flux analyzer 13, as well as monitoring the suction lift of the depressurizing filtration pump 5.

The control unit 40 of the membrane filtration apparatus 50 according to the present embodiment executes the filtration operation by using pressure as a driving force for the membrane module 4. Furthermore, the control unit 40 performs backwash operation in which a mixture of permeate and an oxidizing agent is fed from the permeate side of the membrane module 4 to the feed side thereof together with air scrubbing thereof.

The control unit 40 effectively prevents membrane clogging by alternately performing filtration operation and the backwash operation.

### (Filtration Operation)

First, the filtration operation executed by the control unit 40 will be described. There are three modes in the filtration operation executed by the control unit 40: outside-in mode with pressure applied to the feed side, outside-in mode with negative pressure applied to the permeate side, and a combination thereof.

### (Raw Water Side Pressure Filtration)

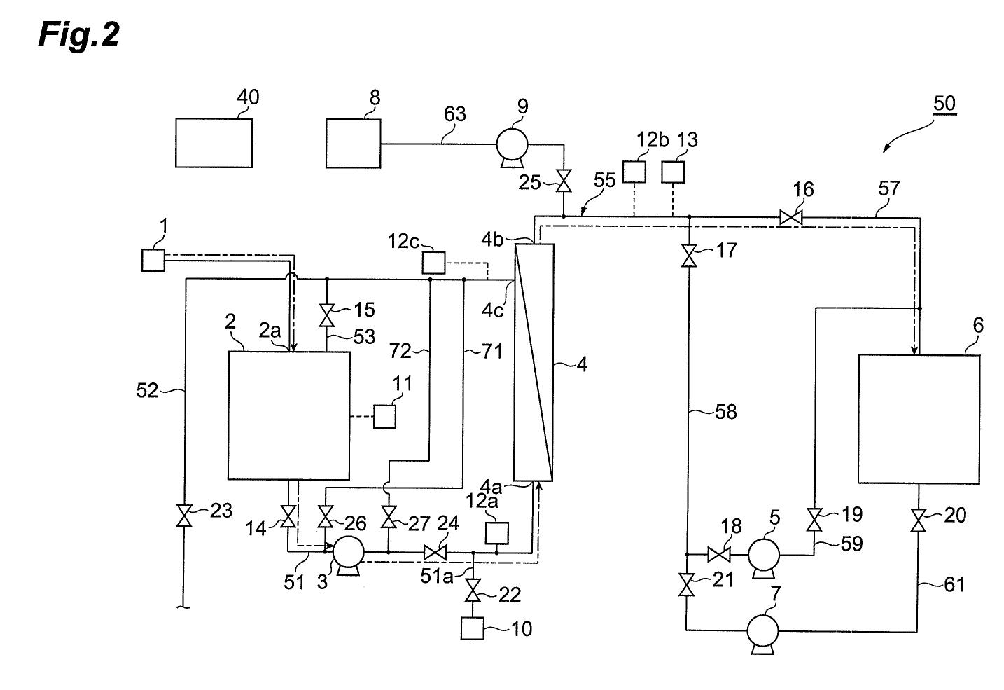

As shown in FIG. 2, when conducting filtration operation in outside-in mode, the control unit 40 opens the valves 14 and 24 provided on the raw water inlet pipeline 51, and opens the valve 16 provided on the first pipeline 57 of the permeate pipeline 55, and in addition thereto, closes the valve 22 for supplying air for scrubbing, the valve 25 for supplying the oxidizing agent and the valve 17 provided on the second pipeline 58 of the permeate water pipeline 55. As a result thereof, a fluid conduit for the raw water side pressure filtration is formed.

Next, the control unit 40 activates the pressure regulating filtration pump 3. As shown in FIG. 2, the raw water 1 is pressure fed so as to pass through the raw water tank 2 to the membrane module 4, via the activation of the pressure regulating filtration pump 3. The permeate water that has passed through the membrane module 4 is delivered to the permeate tank 6 by passing through the first pipeline 57 of the permeate pipeline 55.

Moreover, this becomes dead-end filtration when valve 15 provided on the raw water circulating pipe 53 is closed, and cycle filtration when this valve is opened.

### (Permeate Side Negative Pressure Filtration)

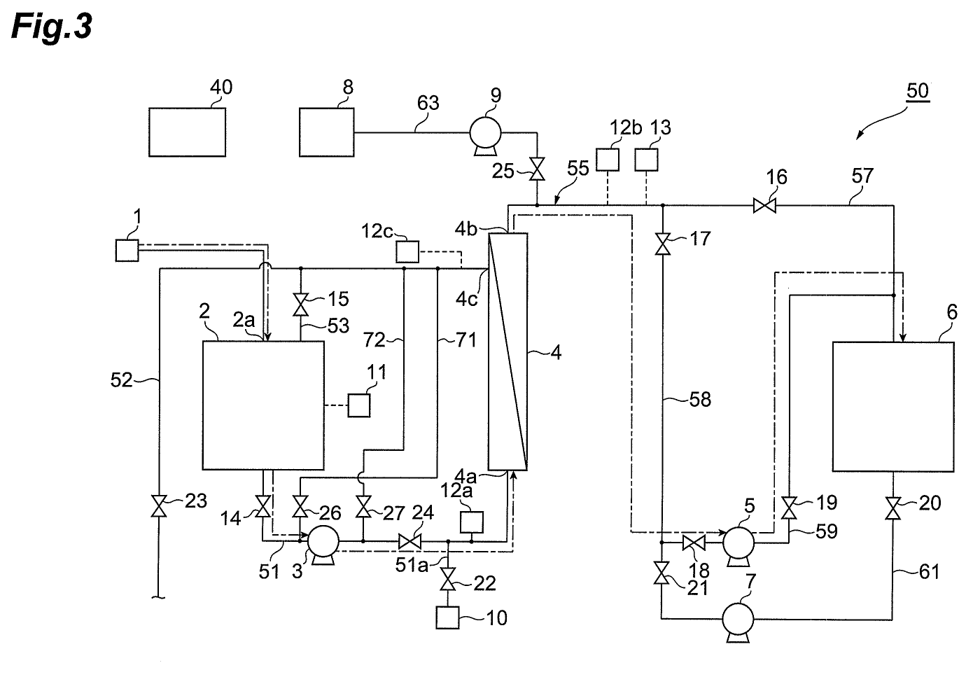

As shown in FIG. 3, when conducting the permeate side negative pressure filtration, the control unit 40 opens the valves 14 and 24 provided on the raw water side inlet pipeline 51, opens the valve 17 provided on the second pipeline 58 of the permeate water pipeline 55, and opens the valves 18 and 19 provided on the filtered side pipeline 59 of the second pipeline 58. In addition, it closes the valve 22 supplying the air for air scrubbing, closes the valve 25 supplying the oxidizing agent, and closes the valve 16 provided on the first pipeline 57 of the permeate pipeline 55. As a result thereof, a fluid conduit for the permeate side negative pressure filtration is formed. Moreover, a fluid conduit for the permeate side negative pressure filtration and a fluid conduit for the composite filtration are the same.

Next, the control unit 40 controls the activation of the pressure regulating filtration pump 3 and the depressurizing filtration pump 5. As a result of the activation control of the control unit 40, the raw water 1 passes through the raw water tank 2 and is delivered to the membrane module 4 via the pressure regulating filtration pump 3, and the pressure is reduced via the depressurizing filtration pump 5 connected to the permeate side of the membrane module 4, so as to obtain permeate water. In the permeate side negative pressure filtration according to the present embodiment, the control unit 40 controls the activation of the pressure regulating filtration pump 3 so as to have the minimum pressure to allow for the raw water 1 to be supplied to the membrane module 4. Accordingly, the driving force for obtaining permeate is essentially applied by the depressurizing filtration pump 5 alone. Alternately, a pipe that bypasses pressure regulating filtration pump 3 may be provided, where the operation of the pump is under suspension and a valve is used to switch liquid passes.

### (Composite Filtration)

As shown in FIG. 3, when conducting the composite filtration, the control unit 40 forms a fluid conduit similar to the fluid conduit for the permeate side negative pressure filtration. Then, the control unit 40 activates the depressurizing filtration pump 5 and the pressure regulating filtration pump 3, which also acts in the supply of raw water. As a result thereof, the raw water 1 passes through the raw water tank 2b and is delivered to the membrane module 4 via the pressure regulating filtration pump 3, and pressurization and depressurization are both simultaneously conducted by depressurization of the permeate side via the depressurizing filtration pump 5, so as to obtain permeate. The obtained permeate is stored in the permeate water tank 6, which also acts as a backwash tank.

### (Backwash Operation)

Moreover, it is preferable that physical cleaning such as backwashing or air scrubbing is performed in cases where the transmembrane pressure difference is increased by continuing the filtration operation. Backwashing is a method for removing membrane fouling substances adhering to the membrane surface on the raw water side or clogging membrane pores, by flushing permeate from the permeate side of the membrane module 4 to the raw water side thereof. Air scrubbing is a method for removing membrane fouling substances adhering to the membrane surface on the raw water side by shaking and scrubbing the membrane surface on the raw water side such as with air bubbles. In cases where the pressure actually applied on the raw water side is low and the pressure on membrane fouling substances is not high, it is thought that such substances can be removed with ease by physical cleaning.

The membrane filtration apparatus 50 according to the present embodiment repeatedly alternates between the execution of the abovementioned filtration operation and the backwash operation. Hereinafter, the backwash operation executed by the control unit 40 of the membrane filtration apparatus 50 will be described. There are three modes in the backwash operation according to the present invention: permeate side pressure backwashing, raw water side negative pressure backwashing, and composite backwashing combining the permeate side pressure backwashing and the permeate side pressure backwashing.

### (Permeate Side Pressure Backwashing)

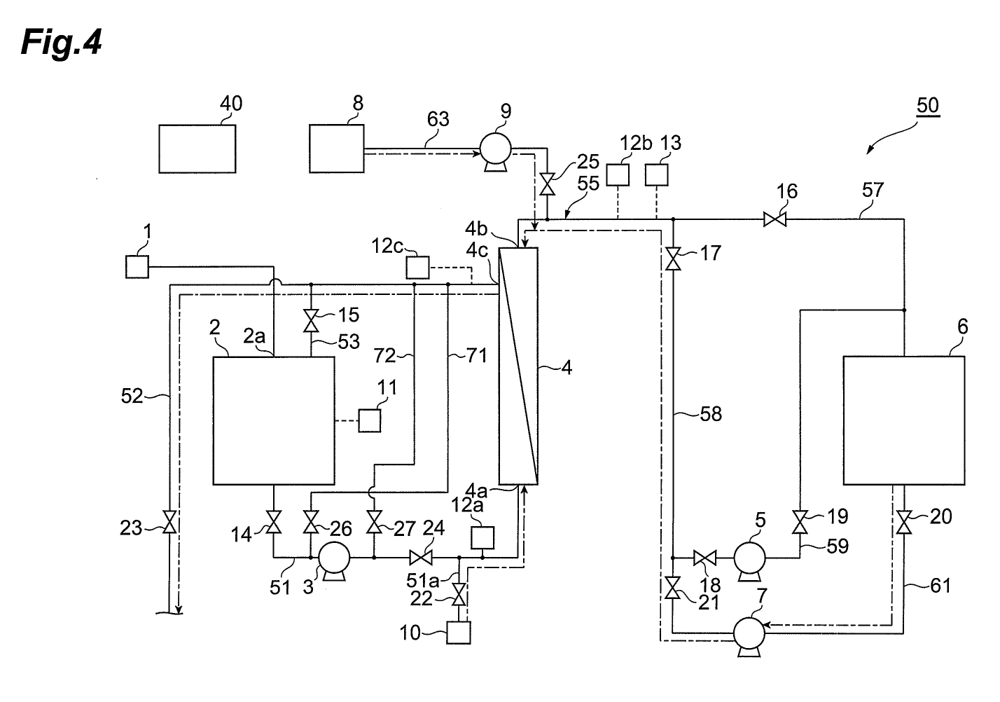

As shown in FIG. 4, a backwash step and a waste liquid step are performed in the permeate side pressure backwashing. First, the control unit 40 opens the valve 17 provided on the second pipeline 58 of the permeate water pipeline 55, opens the valves 20 and 21 provided on the backwash side pipeline 61, and then opens the valve 23 provided on the drainage discharge pipeline 52. On the other hand, the valve 18 provided on the filtered side pipeline 59 and the valve 24 provided on the raw water inlet pipeline 51 are closed. As a result thereof, a fluid conduit for backwashing is formed. Moreover, in accordance with formation of a fluid conduit for backwashing, the valve 25 provided on the chemical solution supply pipeline 63 is opened to supply the oxidizing agent to the membrane module 4, and the valve 22 provided on the air inlet pipe 51a is opened to supply air for the air scrubbing of the membrane module 4.

Next, the control unit 40 activates the pressure backwashing pump 7, and pressure feeds the permeate stored in permeate tank 6, which also acts as the backwash tank to the membrane module 4. Furthermore, the control unit 40 performs backwashing by activating the oxidizing agent solution feed pump 9, producing a liquid mixture by adding the oxidizing agent to the permeate for backwashing via the chemical solution supply pipeline 63, and delivering the liquid mixture from the permeate side of the membrane module 4 to the raw water side. In addition, the control unit 40 performs the air scrubbing of the membrane by activating compressor 10, and supplying compressed air to the raw water side 1 of the membrane module 4 via the air inlet pipe 51a.

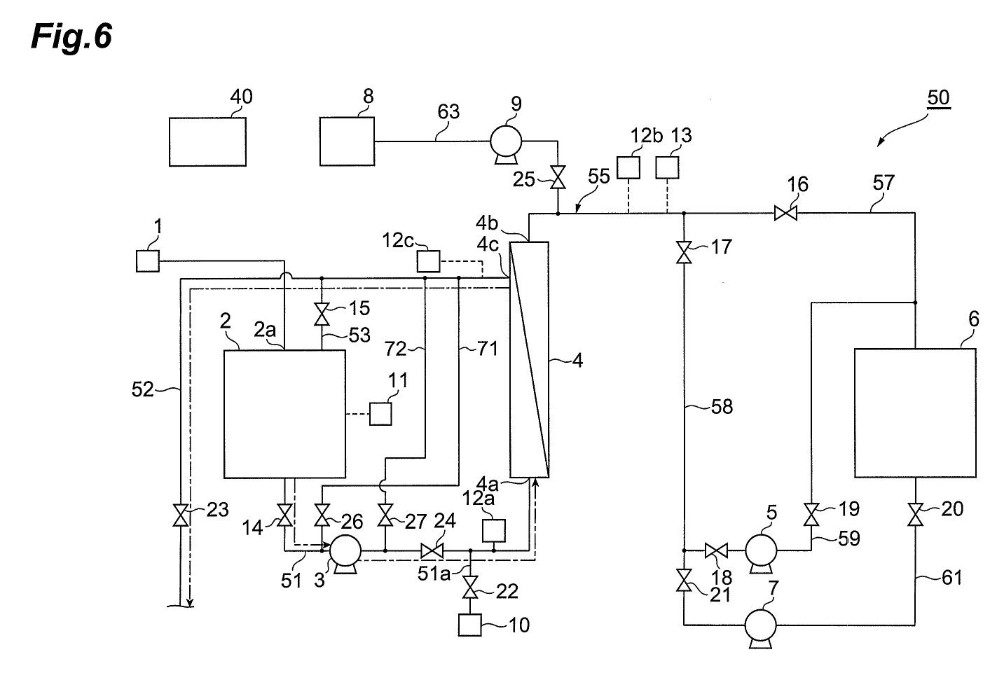

After the abovementioned backwashing step, the control unit 40 performs wastewater drainage step. As shown in FIG. 6, the wastewater drainage step is a step for discharging the substances removed from the membrane during the backwashing step. In the discharge step, the control unit 40 opens the valves 14 and 24 of the raw water inlet pipeline 51 and the valve 23 of the drainage discharge pipeline 52, and forms a liquid conduit for discharging liquid by closing the other valves such as valves 16, 17, 22 and 25.

Next, the control unit 40 activates the pressure regulating filtration pump 3, and supplies the raw water 1 to the membrane module 4, where the removed substances on the raw water 1 side of the membrane module 4 is discharged to the drainage discharging pipeline 52 through the retentate outlet 4c of the membrane module 4 together with the raw water 1.

### (Raw Water Side Negative Pressure Backwashing)

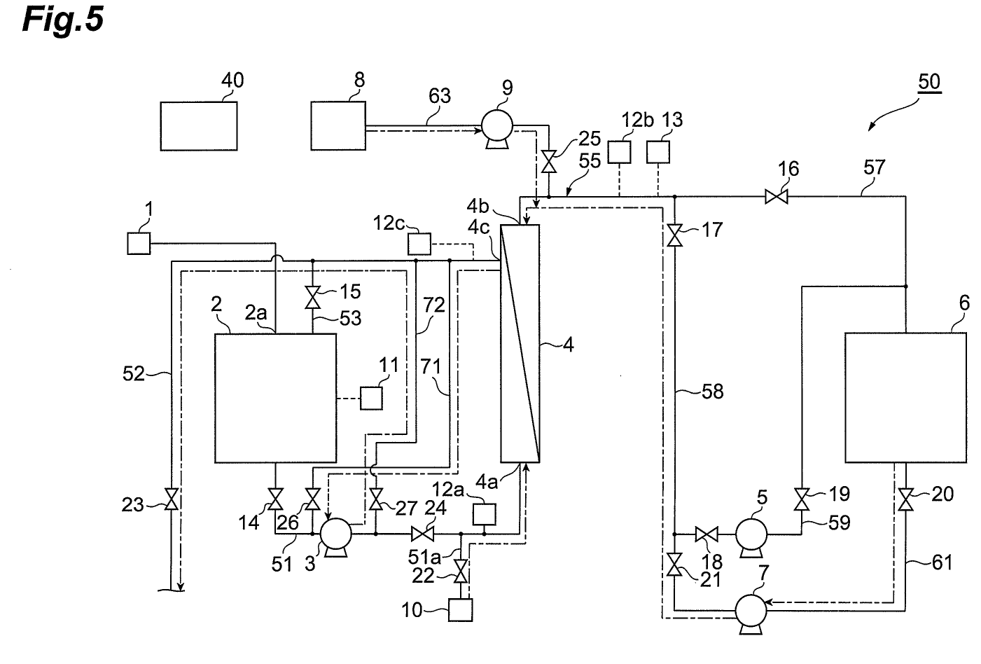

As shown in FIG. 5, wastewater is drained simultaneously with backwash step in which negative pressure is applied to the raw water side. In the backwash step, the control unit 40 opens the valve 17 provided on the second pipeline 58 of the permeate water pipeline 55, opens the valves 20 and 21 provided on the backwash side pipeline 61, opens the valve 23 provided on the drainage discharging pipeline 52, and opens the valves 26 and 27 provided on the second backwash pipeline 72 and the first backwash pipeline 71 communicating with the pressure regulating filtration pump 3. On the other hand, the valve 18 provided on the filtration side pipeline 59, and the valves 14 and 24 provided on the raw water inlet pipeline 51 are closed. As a result thereof, a fluid conduit for backwashing is formed. Moreover, the valve 22 for supplying the air for air scrubbing and the valve 25 for supplying the oxidizing agent are opened.

Next, control unit 40 controls Pressure adjusting filtration pump 3 so as to form negative pressure on the raw water side of the membrane module 4, and further controls pressure backwash pump 7. Thus the permeate stored permeate tank 6, which also serves as a backwash tank, is fed to Membrane module 4 for backwashing, induced by the negative pressure that is formed on the raw water side of the module by Pressure adjusting filtration pump 3 connected to the side. In the raw water side pressure backwashing according to the present embodiment, the control unit 40 controls pressure backwash pump 7 so as to have the minimum pressure to allow for the permeate to be supplied to the membrane module 4. Accordingly, the driving force for backwashing is essentially applied via the pressure regulating filtration pump 3 alone. Alternately, a pipe that bypasses pressure backwash pump 7 may be provided, where the operation of the pump is under suspension and a valve is used to switch liquid passes.

After the abovementioned backwashing step, the control unit 40 executes a waste liquid step similar to the waste liquid step of the permeate side pressure backwashing (refer to FIG. 6).

### Composite Backwashing

As shown in FIG. 5, a backwashing step and a waste liquid step are performed in the composite backwashing. In the backwashing step, the control unit 40 forms a fluid conduit for backwashing similar to that of the raw water side negative pressure backwashing, and also opens the valve 22 for supplying air for air scrubbing and the valve 25 for supplying the oxidizing agent.

Next, control unit 40 controls Pressure adjusting filtration pump 3 so as to provide negative pressure on the raw water side of the membrane module 4 and further controls Pressure backwash pump 7. Thus backwash is performed by allowing pressure backwash pump 7 to feed the permeate stored in the permeate water tank 6, which also serves as a backwash tank, to Membrane module 4 and by simultaneously forming negative pressure for suction on the raw water side of the module, using Pressure adjusting filtration pump 3.

After the abovementioned backwashing step, the control unit 40 executes a wastewater drainage step similar to the wastewater drainage step of the permeate side pressure backwashing (refer to FIG. 6).

### Switching Control

The raw water side water quality measured by the water quality analyzer 11, the transmembrane pressure measured by the transmembrane pressure gauge 12, and the membrane permeate flux measured by permeate flowmeter 13 are all monitored by the control unit 40. Accordingly, the control unit 40 controls the switching of any one filtration mode from among the abovementioned three filtration modes to another filtration mode, in response to at least one of each measured value. The switching control performed by the control unit 40 will be described hereinafter.

The switching control may be one in which, for example, the raw water side water quality is obtained as the measured value by the control unit 40, and the characteristic value X indicating a concentration of a membrane fouling-causing substance is calculated from the obtained measured value, so that the raw water side pressure filtration is conducted when the characteristic value X thereof falls below a predetermined threshold value, and the raw water side pressure filtration switches to the composite filtration when the characteristic value X thereof rises above a predetermined threshold value.

The characteristic value X is calculated from the raw water side water quality. The categories of the raw water side water quality include: turbidity (NTU), TOC (mg/L), CODMn (mg/L), CODCr (mg/L), BOD (mg/L), and the concentrations of metals such as Fe (mg/L), Mn (mg/L), Al (mg/L), Si (mg/L), Ca (mg/L), and Mg (mg/L). The corresponding water quality analyzer therefor may be installed and the measured water quality value therefrom employed as the characteristic value X indicating the membrane fouling substances. The water quality analyzer 11 according to the present embodiment measures at least one selected from the turbidity (NTU) and the TOC (mg/L), so as to calculate the characteristic value X from each measured value. For example, the characteristic value X may be calculated from the turbidity (NTU) alone or the TOC (mg/L) alone, or may be calculated from the turbidity (NTU) and TOC (mg/L). In cases where the characteristic value X is calculated from the turbidity (NTU) and TOC (mg/L), it may be calculated as the value of X=A+B, with the turbidity being A (NTU), and the TOC being B (mg/L). In addition, the TOC (mg/L) is the total organic carbon content.

Furthermore, in cases where the turbidity is employed as the characteristic value X, it is preferably that the threshold value is set as a threshold value in which the turbidity is 0.01 NTU to 100 NTU, and more preferably set at 1 NTU to 100 NTU. In cases where the TOC is employed as the characteristic value X, it is preferably that the threshold value is set as a threshold value in which Toc is 0.01 mg/L to 1000 mg/L, and more preferably set at 1 mg/L to 100 mg/L. In cases where the turbidity and the TOC (A+B) are employed as the characteristic value X, it is preferably that the threshold value is set as a threshold value in which the value of A+B is 0.01 mg/L to 1000 mg/L, and more preferably set as a threshold value in which the value of A+B is 1 mg/L to 100 mg/L.

Moreover, as a mode other than the switching control, for example, the membrane filtration flux is obtained by the control unit 40 as the measured value, so that during constant flow rate filtration operation at the design flow rate based on the permeate side negative pressure filtration, the permeate side negative pressure filtration may switched to the raw water side pressure filtration or the composite filtration when the obtained value falls below a predetermined membrane filtration flux.

In addition, as a mode other than the switching control, for example, the suction lift of the permeate side corresponding to the transmembrane pressure difference is obtained by the control unit 40 as a measured value, so that during constant flow rate filtration operation at a design flow rate based on the permeate side negative pressure filtration, the permeate side negative pressure filtration may be switched to the raw water side pressure filtration or the composite filtration when the available NPSH is reached by the suction lift of the permeate side.

The timing or control of switching may take in manners different from those mentioned above. Hereinafter, the actions/effects of the switching control by the control unit 40 will be described.

The raw waters preferably treated in the present embodiment is clean water, an industrial water supply, river water, lake water, ground water, reservoir water, secondary treated sewage effluent, drainage, sewage, or the like. Because cake layers are formed or membrane pores are clogged by membrane fouling substances contained in Raw water 1, membrane filtration resistance increases over time in fixed flow rate operation, which further increases transmembrane pressure.

With regard to filtration operation performed at a fixed permeate flux to treat raw water having either high turbidity or a high level of total organic carbon (TOC) due to a large amount of the membrane fouling substances contained therein, the inventors of the present invention have found that transmembrane pressure increases more quickly when positive pressure is applied to the raw water side than when negative pressure is applied to the permeate side.

Furthermore, the occurrence of fluctuations in the water quality of the abovementioned raw water 1 is typical, and as such, the amount of the membrane fouling-causing substance also fluctuates. The inventors of the present invention have found that, although membrane fouling rapidly progresses when the membrane fouling substances in Raw water 1 increase rapidly, the increase in transmembrane can be better prevented during filtration performed by applying negative pressure to the permeate side than by applying positive pressure to the raw water side.

The difference between the permeate side negative pressure filtration and the raw water side pressure filtration mentioned above is thought to occur as a result of the difference in the pressure actually applied to the raw water side of the membrane in which membrane fouling substances are present. Specifically, the pressure actually applied to the raw water side in the raw water side pressure filtration is the sum of the atmospheric pressure and the transmembrane pressure difference, while the pressure actually applied to the raw water side in the permeate side negative pressure filtration becomes the atmospheric pressure, and the pressure actually applied to the raw water side becomes higher by the difference caused by the transmembrane pressure than in filtration with negative pressure applied to the permeate side.

In a case where both the raw water side pressure filtration and the permeate side negative pressure filtration are being operated with the same membrane filtration flux, the initially applied transmembrane pressure is the same, and the pressure applied towards the membrane fouling substances within the raw water 1 in a direction perpendicular to the membrane is the same. However, the actual pressure on a membrane surface where a membrane fouling-causing substance is accumulated is higher only for the atmospheric portion of the raw water side pressure filtration when compared with the permeate side negative pressure filtration. Accordingly, it is thought that the shapes of the particles of the membrane fouling substances are changed by being further compressed in the raw water side negative pressure filtration, so that the cake layer formed on the membrane surface becomes denser. It is thought when backwashing and air scrubbing are simultaneously performed in the above state, the efficiency of backwashing in the raw water side pressure filtration with a denser cake layer is reduced. Therefore, when continuing the filtration operation over a long period of time, the increase in the pressure of raw water side pressure filtration operating at the same membrane filtration flux is faster when compared with the permeate side negative pressure filtration. The difference is that although the amount of the membrane fouling substances included in the raw water is small enough to be negligible, the amount of the membrane fouling substances exceeding a fixed value is remarkable. Accordingly, when considered solely on the basis of the efficiency of backwashing and the like, it is thought that the permeate side negative pressure filtration is even more advantageous than the raw water side pressure filtration is.

However, since the maximum transmembrane pressure is the atmospheric pressure in filtration by negative pressure on the permeate side, this filtration cannot be performed alone and the membrane filtration flux of the design cannot be assured in conditions where the transmembrane pressure is at least the atmospheric pressure. Specifically, in cases where the raw water is low in the membrane fouling substances, because of being typically operated at a high membrane filtration flux and because of high transmembrane pressure during constant flow filtration, solely performing filtration by the application of negative pressure is not possible. Accordingly, the raw water side pressure filtration or the composite filtration is necessary.

In such a case, since the pressure actually applied to the raw water side of the membrane is reduced when the amount of the membrane fouling substance is high, it is more preferable that the composite filtration is selected, that the contribution of the permeate side reduction filtration as the driving force for extracting permeate water is as high as possible, and that the insufficient portion of the membrane filtration flux is compensated for by the raw water side pressure filtration. On the other hand, when the amount of the membrane fouling substances is low, operating via raw water side pressure filtration alone may be advantageous when considering energy efficiency, and the lifespan of the pump may be lengthened considerably by minimizing the time and the frequency of usage of the permeate side depressurizing pump.

Specifically, according to the membrane filtration apparatus 50 and the filtration method executed via the membrane filtration apparatus 50, because the mode of filtration is switched so as to optimize the filtration operation in accordance with changes in the membrane filtration flux or the transmembrane pressure and fluctuations in the water quality of the raw water 1, having a high membrane filtration flux even when the water quality of the raw water fluctuates allows for the frequency of chemical cleaning to be reduced by preventing an increase in the transmembrane pressure, and for the lifespan of the pump to be lengthened considerably by minimizing energy consumption. As a result thereof, a designed membrane filtration flux may be assured as is, an increase in the transmembrane pressure difference may be prevented, and a filtration operation may be stably continued over a long period of time.

Moreover, in the membrane filtration apparatus 50 and the filtration method executed via the membrane filtration apparatus 50, selecting and executing at least one backwashing mode from the permeate side pressure backwashing, the raw water side negative pressure backwashing, and the composite backwashing, allows for effective backwashing.

For example, when the raw water side negative pressure backwashing is compared with the permeate side pressure backwashing, the actual pressure on a membrane surface in which a membrane fouling-causing substance is accumulated is decreased only for the atmospheric pressure portion.

Accordingly, it is thought that the compression of the membrane fouling substance accumulated on the membrane surface is alleviated, and thus the backwashing effect is high. On the other hand, similarly to the filtration method, it is thought using composite backwashing even in cases where the backwashing flux of the design cannot be assured in the raw water side negative pressure backwashing alone, allows for appropriate backwashing by increasing the contribution of the raw water side negative pressure backwashing as the driving force for extracting backwash as much as possible, and by compensating for the insufficient portion via the permeate side negative pressure backwashing.

Although the embodiments of the present invention have been described above, the present invention is not specifically limited to the above embodiments. For example, with regard to the first and second pressure regulating device for conducting the raw water side pressure filtration, the permeate side negative pressure filtration, the composite filtration, the permeate side pressure backwashing, the raw water side negative pressure backwashing and the composite backwashing, a pressure pump, a pressure regulating pump, a high pressure gas, a water head difference and the like may be exemplified as the pressure device, and a suction pump, a vacuum pump and the like may be exemplified as the negative pressure device.

### EXAMPLES

### Example 1

Surface stream water with an average turbidity of 1 NTU was employed as the raw water. A filtration operation and backwashing operation were conducted using an apparatus corresponding to the abovementioned membrane filtration apparatus 50. The filtration operation was started with raw water side pressure filtration. A signal from a water quality analyzer 11 was sent to a control unit 40, and it was automatically switched to composite filtration via the control unit 40 once a measured value reached 5 NTU.

The raw water side pressure filtration was performed in dead-end filtration mode, in which a constant flow rate filtration was set to supply raw water 1 at a constant flow rate (membrane filtration flow of 2.5 m³/m²/day, the obtained flow rate of the permeate water for one day was 2.5 m³ per one meter squared of membrane area) using pressure regulating pump 3 for membrane module 4.

The composite filtration was performed in dead-end mode, in which a constant flow rate filtration was set for supplying raw water 1 at a constant flow rate (membrane filtration flow of 2.5 m³/m²/day, the obtained flow rate of the permeate water for one day was 2.5 m³ per one meter squared of membrane area) using pressure regulating pump 3 providing negative pressure by vacuum pump 5. The current frequency of vacuum pump 5 for the composite filtration was 50 Hertz, which was the maximum rotation speed of the pump.

In the present Example, the raw water side pressure filtration or the composite filtration was repeatedly alternated with a cleaning operation, and the operating conditions of a 29 minute filtration operation, a one minute simultaneous backwashing and scrubbing as the backwash operation, and a 30 second discharging were repeated. The backwash operation was performed at 3.0 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and the air scrubbing was performed at an airflow rate of 1.5 Nm³/hr.

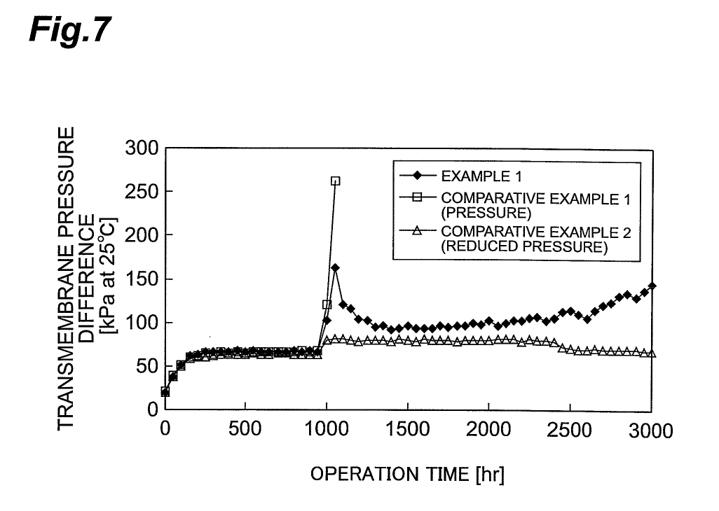

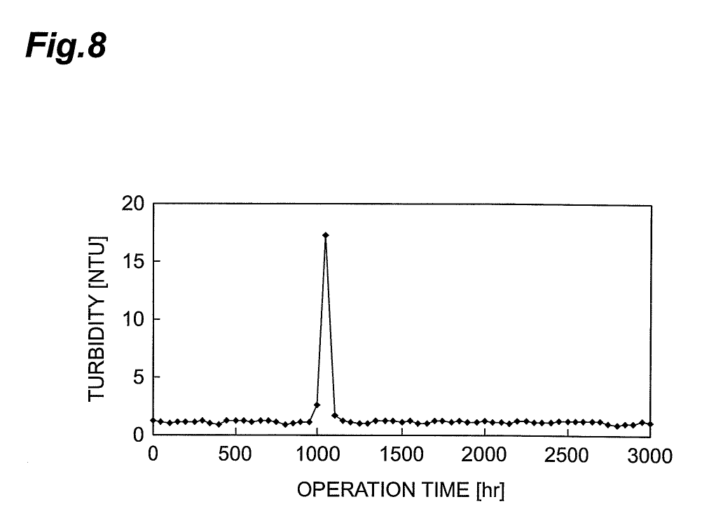

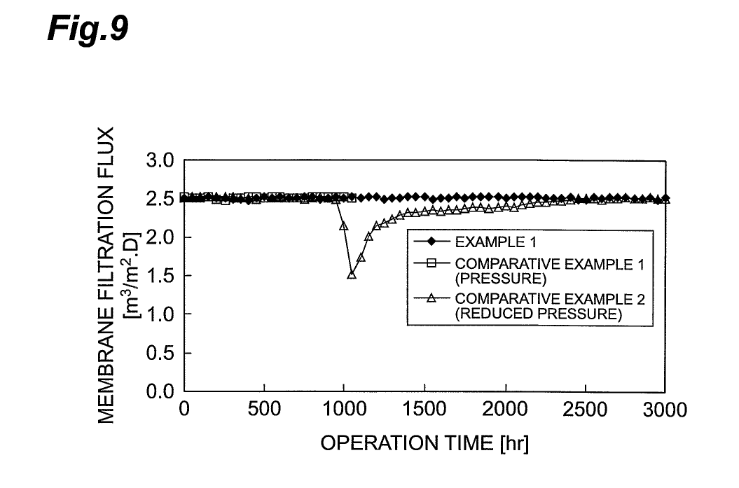

Since the turbidity exceeded 5 NTU and reached 17 NTU after approximately 1000 hours (refer to FIG. 8) after continuous operation was started under the abovementioned conditions, the raw water side pressure filtration method automatically switched to the composite filtration. The transmembrane pressure increased to a maximum of 163 kPa, and was 145 kPa after 3000 hours (refer to FIG. 7). Continuous operation was possible with the predetermined membrane filtration flux of 2.5 m³/m²/day being maintained as is for up to 3000 hours (refer to FIG. 9).

### Comparative Example 1

Surface stream water with an average turbidity of 1 NTU was employed as the raw water. The filtration operation and backwash operation were conducted using an apparatus provided with a structure similar to the that of Example 1 with the exception of the control unit 40, and the filtration operation was concurrently performed with Example 1 via raw water side pressure filtration. The raw water side pressure filtration was performed in dead-end filtration mode, in which a constant flow rate filtration was set to supply raw water 1 at a constant flow rate (membrane filtration flow of 2.5 m³/m²/day, the obtained flow rate of the permeate for one day was 2.5 m³ per one meter squared of membrane area) using pressure regulating pump 3 for membrane module 4.

A 29 minute filtration operation, a one minute simultaneous backwashing and scrubbing as the backwash operation, and a 30 second discharging were repeated as the operating parameters of Comparative Example 1. The backwash operation was performed at 3.0 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and the air scrubbing was performed at an airflow rate of 1.5 Nm³/hr. Since the transmembrane pressure became the 200 kPa required for chemical cleaning approximately 1050 hours after starting continuous operation under the abovementioned conditions, the apparatus was stopped (refer to FIG. 7).

### Comparative Example 2

Surface stream water with an average turbidity of 1 NTU was employed as the raw water. The filtration operation and backwash operation were conducted using an apparatus provided with a structure similar to that of Comparative Example 1, and the filtration operation was concurrently performed with Example 1 via permeate side negative pressure filtration. The permeate side negative pressure filtration was performed in dead-end mode, in which a constant flow rate filtration was set to supply raw water 1 at a constant flow rate (membrane filtration flow of 2.5 m³/m²/day, the obtained flow rate of the permeate water for one day was 2.5 m³ per one meter squared of membrane area) using pressure regulating pump 3 for membrane module 4.

A 29 minute filtration operation, a one minute simultaneous backwashing and scrubbing as the backwash operation, and a 30 second discharging were repeated as the operating parameters of Comparative Example 2. The backwash operation was performed at 3.0 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and the air scrubbing was performed at an airflow rate of 1.5 Nm³/hr. The membrane filtration flux fell below the design membrane filtration flux of 2.5 m³/m²/day to become a minimum of 1.5 m³/m²/day (refer to FIG. 9) approximately 1000 hours after starting continuous operation under the abovementioned conditions.

### Example 2

Surface stream water with an average turbidity of 0.1 NTU was employed as the raw water. The filtration operation and backwash operation were conducted using an apparatus provided with a structure similar to that of Example 1, the filtration operation was started via permeate side negative pressure filtration, and automatically switched to a filtration method combining the raw water side pressure filtration and the permeate side negative pressure filtration once the measured value of a transmembrane pressure gauge 12 reached 80 kPa. The rotation speed of vacuum filtration pump 5 was fixed for the filtration method combining filtration by positive pressure on the raw water side and filtration by negative pressure on the permeate side when the transmembrane pressure reached 80 kPa.

The composite filtration was performed in dead-end filtration mode, in which a constant flow rate filtration was set for supplying raw water 1 at a constant flow rate (membrane filtration flow of 5.0 m³/m²/day, the obtained flow rate of the permeate for one day was 5.0 m³ per one meter squared of membrane area) using pressure regulating pump 3 for membrane module 4, while simultaneously providing negative pressure using vacuum filtration pump 5.

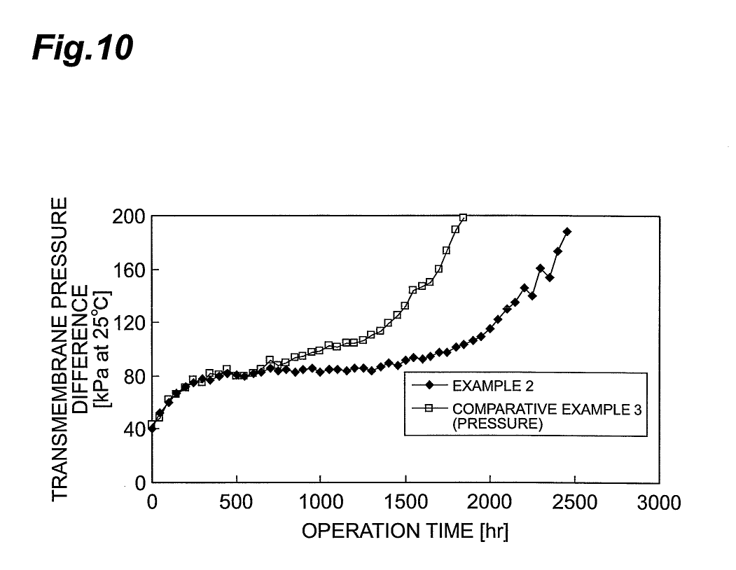

A 29 minute filtration operation, a one minute simultaneous backwashing and scrubbing as the backwash operation, and a 30 second discharging were repeated as the operating parameters of Example 2. The backwash operation was performed at 3.8 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and air scrubbing was performed at an airflow rate of 1.5 Nm³/hr. Since the transmembrane pressure reached 80 kPa after approximately 400 hours after starting continuous operation under the abovementioned conditions, the permeate side negative pressure filtration method was switched to the composite filtration. Stable filtration was continued for approximately 2000 hours until the transmembrane pressure became the 200 kPa required for chemical cleaning after approximately 2500 hours (refer to FIG. 10).

### Comparative Example 3

Surface stream water with an average turbidity of 0.1 NTU was employed as the raw water. The filtration operation and backwash operation were conducted using an apparatus provided with a structure similar to that of Comparative Example 1, and the filtration operation was conducted via raw water side pressure filtration. The raw water side pressure filtration was performed in dead-end operation mode, in which a constant flow rate filtration was set to supply raw water 1 at a constant flow rate (membrane filtration flow of 5.0 m³/m²/day, the obtained flow rate of the permeate water for one day was 5.0 m³ per one meter squared of membrane area) using pressure regulating pump 3 for membrane module 4.

A 29-minute filtration operation, a one-minute simultaneous backwashing and scrubbing as the backwash operation, and a 30-second discharging were repeated as the operating parameters of Comparative Example 3. The backwash operation was performed at 3.8 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and air scrubbing was performed at an airflow rate of 1.5 Nm³/hr. The stable operating time was reduced, and the transmembrane pressure became the 200 kPa required for chemical cleaning after approximately 1900 hours (refer to FIG. 10) after continuous operation under the abovementioned conditions.

### Example 3

River water sand filter backwash and drainage with an average turbidity of 100 NTU were employed as the raw water. The filtration operation and backwash operation were conducted using an apparatus provided with a structure similar to that of Example 1, the filtration operation was started via permeate side negative pressure filtration, and automatically switched to composite filtration at a point where the measured value of a membrane filtration flux analyzer 13 fell below the design membrane filtration flux of 1.0 m³/m²/day. The current frequency at which the depressurizing pump 5 of the composite filtration was operated was 50 Hertz, which was the maximum output speed. The composite filtration was performed in dead-end filtration mode, in which a constant flow rate filtration was set for supplying raw water 1 at a constant flow rate (membrane filtration flow of 1.0 m³/m²/day, the obtained flow rate of the permeate water for one day was 1.0 m³ per one meter squared of membrane area) using pressure regulating pump 3 for membrane module 4, while simultaneously providing negative pressure using vacuum filtration pump 5.

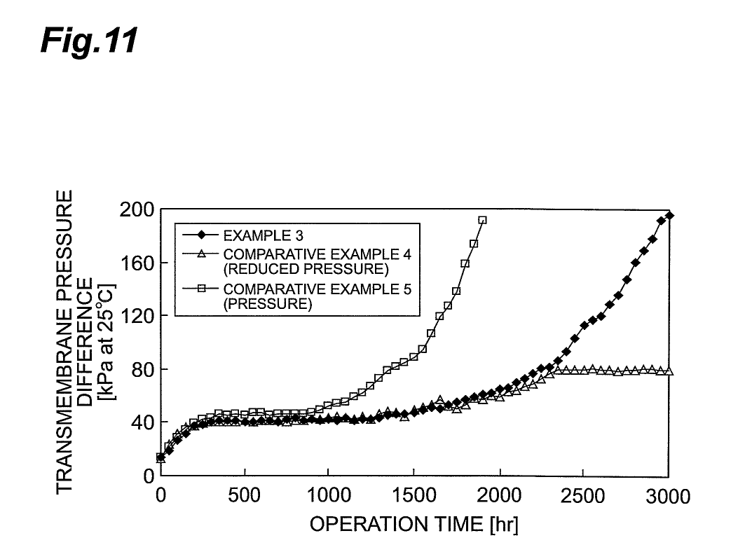

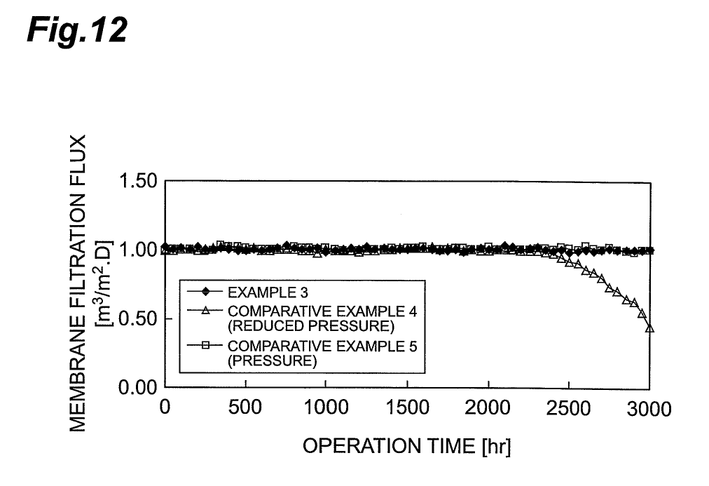

A 29-minute filtration operation, a one-minute simultaneous backwashing and scrubbing as the backwash operation, and a 30-second discharging were repeated as the operating parameters of Example 3. The backwash operation was performed at 1.0 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and air scrubbing was performed at an airflow rate of 1.5 Nm³/hr. Since the measured value of a membrane filtration flowmeter 13 fell below the design membrane filtration flux of 1.0 m³/m²/day approximately 2250 hours after starting continuous operation under the abovementioned conditions, the permeate side negative pressure filtration method was automatically switched to the composite filtration. The transmembrane pressure became the 200 kPa required for chemical cleaning after approximately 3000 hours (refer to FIG. 11), and operation at the design filtration flux of 1.0 m³/m²/day was possible for approximately 3000 (refer to FIG. 12).

### Comparative Example 4

River water sand filter backwash water with an average turbidity of 100 NTU was employed as the raw water. The filtration operation and backwash operation were conducted using an apparatus provided with a structure similar to that of Comparative Example 1, and the filtration operation was conducted via permeate side negative pressure filtration. The permeate side negative filtration was performed in dead-end filtration mode, in which a constant flow rate filtration was set for supplying raw water 1 at a constant flow rate (membrane filtration flow of 1.0 m³/m²/day, the obtained flow rate of the permeate water for one day was 1.0 m³ per one meter squared of membrane area) using pressure regulating pump 3 for membrane module 4, while simultaneously providing negative pressure using vacuum filtration pump 5.

A 29-minute filtration operation, a one-minute simultaneous backwashing and scrubbing as the backwash operation, and a 30-second discharging were repeated as the operating parameters of Comparative Example 4. The backwash operation was performed at 1.0 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and air scrubbing was performed at an airflow rate of 1.5 Nm³/hr. The membrane filtration flux fell below the design membrane filtration flux of 1.0 m³/m²/day after approximately 2300 hours to become 0.45 m³/m²/day approximately 3000 hours (refer to FIG. 12) after continuous operation under the abovementioned conditions.

### Comparative Example 5

River water sand filter backwash water with an average turbidity of 100 NTU was employed as the raw water. The filtration operation and backwash operation were conducted using an apparatus provided with a structure similar to that of Comparative Example 1, and the filtration operation was conducted via raw water side pressure filtration. The raw water side pressure filtration was performed in dead-end filtration mode, in which a constant flow rate filtration was set for supplying raw water 1 at a constant flow rate (membrane filtration flow of 1.0 m³/m²/day, the obtained flow rate of the permeate water for one day was 1.0 m³ per one meter squared of membrane area) using pressure regulating pump 3 for membrane module 4.

A 29-minute filtration operation, a one-minute simultaneous backwashing and scrubbing as the backwash operation, and a 30-second discharging were repeated as the operating parameters of Comparative Example 5. The backwash operation was performed at 1.0 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and air scrubbing was performed at an airflow rate of 1.5 Nm³/hr. The membrane pressure became 200 kPa required for chemical cleaning approximately 1950 hours (refer to FIG. 11) after continuous operation under the abovementioned conditions.

### Example 4

Surface stream water with an average turbidity of 2 NTU was employed as the raw water. The filtration operation and backwash operation were conducted using an apparatus provided with a structure similar to that of Example 1, the filtration operation was started via permeate side negative pressure filtration, and automatically switched to the composite filtration at a point where the measured value of a transmembrane pressure gauge 12 reached 80 kPa. The rotation speed of vacuum filtration pump 5 was fixed for the filtration method combining filtration by positive pressure on the raw water side and filtration by negative pressure on the permeate side when the transmembrane pressure reached 80 kPa. The composite filtration was performed in dead-end filtration mode, in which a constant flow rate filtration was set for supplying raw water 1 at a constant flow rate (membrane filtration flow of 1.7 m³/m²/day, the obtained flow rate of the permeate water for one day was 1.7 m³ per one meter squared of membrane area) using pressure regulating pump 3 for membrane module 4, while simultaneously providing negative pressure using vacuum filtration pump 5.

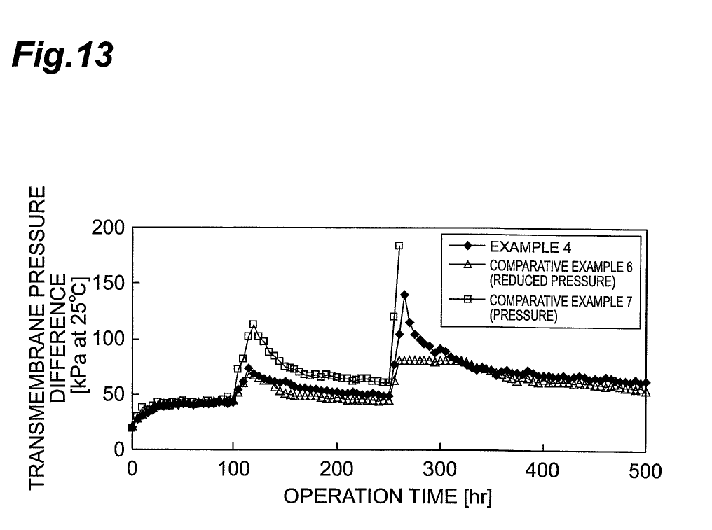

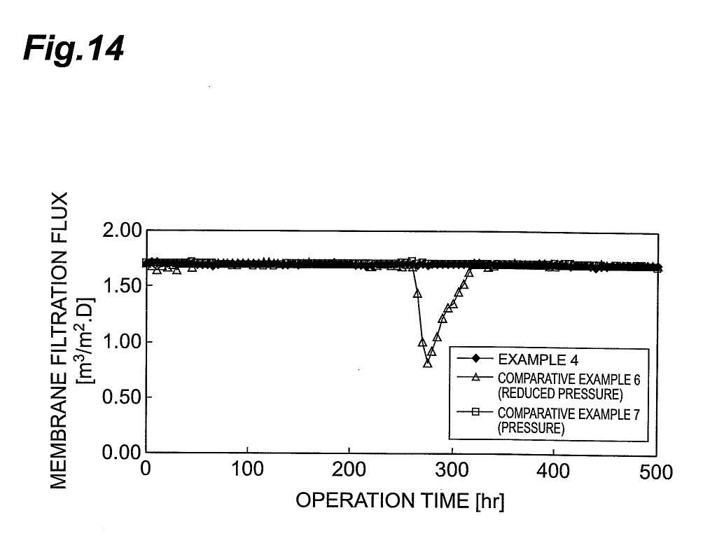

A 29-minute filtration operation, a one-minute simultaneous backwashing and scrubbing as the backwash operation, and a 30-second discharging were repeated as the operating parameters of Example 4. The backwash operation was performed at 1.7 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and air scrubbing was performed at an airflow rate of 1.5 Nm³/hr. The transmembrane pressure became 43 kPa 100 hours after starting a continuous operation from the permeate side negative pressure filtration under the abovementioned conditions. Suspended matter was added after 100 hours, and once the turbidity was approximately 100 NTU, the transmembrane pressure increased to a maximum of 73 kPa and then decreased thereafter. When suspended matter was re-added 250 hours later to bring the turbidity to 100 NTU, because the transmembrane pressure reached 80 kPa after approximately 260 hours (approximately 10 hours after the suspended matter was added), the permeate side negative pressure filtration was automatically switched to the composite filtration. The transmembrane pressure increased to a maximum of 140 kPa and then decreased thereafter to become 63 kPa, after 500 hours (FIG. 13). Operation at the design membrane filtration flux of 1.7 m³/m²/day was possible for 500 hours (FIG. 14).

### Comparative Example 6

Surface stream water with an average turbidity of 2 NTU was employed as the raw water. The filtration operation and backwash operation were conducted using an apparatus provided with a structure similar to that of Example 1, and the filtration operation was conducted via permeate side negative pressure filtration. The permeate side negative pressure filtration was performed in dead-end filtration mode, in which a constant flow rate filtration was set for supplying raw water 1 at a constant flow rate (membrane filtration flow of 1.7 m³/m²/day, the obtained flow rate of the permeate water for one day was 1.7 m³ per one meter squared of membrane area) using pressure regulating pump 3 for membrane module 4, while simultaneously providing negative pressure using vacuum filtration pump 5.

A 29-minute filtration operation, a one-minute simultaneous backwashing and scrubbing as the backwash operation, and a 30-second discharging were repeated as the operating parameters of Comparative Example 6. The backwash operation was performed at 1.7 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and air scrubbing was performed at an airflow rate of 1.5 Nm³/hr. The transmembrane pressure became 45 kPa 100 hours after starting continuous operation under the abovementioned conditions. Suspended matter was added after 100 hours, and once the turbidity was approximately 100 NTU, the transmembrane pressure increased to a maximum of 69 kPa and then decreased thereafter (refer to FIG. 13). After suspended matter was re-added 250 hours later to bring the turbidity to 100 NTU, the membrane filtration flux fell below the design membrane filtration flux of 1.7 m³/m²/day approximately after 260 hours (approximately 10 hours after the suspended matter was added) to reach a minimum membrane filtration flux of 0.82 m³/m²/day (FIG. 14).

### Comparative Example 7

Surface stream water with an average turbidity of 2 NTU was employed as the raw water. The filtration operation and backwash operation were conducted using an apparatus provided with a structure similar to that of Comparative Example 1, and the filtration operation was conducted via raw water side pressure filtration. The raw water side pressure filtration was performed in dead-end filtration mode, in which a constant flow rate filtration was set for supplying raw water 1 at a constant flow rate (membrane filtration flow of 1.7 m³/m²/day, the obtained flow rate of the permeate water for one day was 1.7 m³ per one meter squared of membrane area) using pressure regulating pump 3 for membrane module 4.

A 29-minute filtration operation, a one-minute simultaneous backwashing and scrubbing as the backwash operation, and a 30-second discharging were repeated as the operating parameters of Comparative Example 7. The backwash operation was performed at 1.7 m³/m²/day, and the sodium hypochlorite within oxidizing agent tank 8 was simultaneously supplied using oxidizing agent solution feed pump 9, so that the residual chlorine concentration of the backwash water was 3 mg/L. The gas for scrubbing was air compressed with compressor 10, and air scrubbing was performed at an airflow rate of 1.5 Nm³/hr. The transmembrane pressure difference became 45 kPa 100 hours after starting continuous operation under the abovementioned conditions. Suspended matter was added after 100 hours, and once the turbidity was approximately 100 NTU, the transmembrane pressure increased to a maximum of 113 kPa and then decreased thereafter (refer to FIG. 13). After the suspended matter was re-added 250 hours later to bring the turbidity to 100 NTU, the transmembrane pressure became the 200 kPa required for chemical cleaning after 265 hours (approximately 15 hours after the suspended matter was added) (refer to FIG. 13).

### INDUSTRIAL APPLICABILITY

The present invention may be suitably used in fields applying membrane filtration of clean water, an industrial water supply, river water, lake water, ground water, reservoir water, secondary treated sewage effluent, sewage, drainage and the like, as a raw water source, or applying to membrane filtration for separation of valuable resources or for concentration thereof.

1. A filtration method for filtering raw water to obtain permeate by performing a filtration operation using pressure as a driving force for membrane modules, wherein
the filtration operation is performed in three modes: raw water side pressure filtration, permeate side negative pressure filtration, and composite filtration combining the raw water side pressure filtration and the permeate side negative pressure filtration,
any one of raw water side water quality, membrane filtration flux and transmembrane pressure is measured, and
any one of the three filtration modes is switched to another in response to a measured value thereof.

2. The filtration method according to claim 1, wherein the measured value is a characteristic value X indicating a concentration of a membrane fouling substance calculated from the raw water side water quality, the raw water side pressure filtration is conducted when the characteristic value X falls below a predetermined threshold value, and the raw water side pressure filtration switches to the composite filtration when the characteristic value X rises above a predetermined threshold value.

3. The filtration method according to claim 2, wherein the characteristic value X is calculated from at least one selected from raw water side turbidity A (NTU) and raw water side total organic carbon content (mg/L).

4. The filtration method according to claim 3, wherein the characteristic value X is calculated by X=A+B, when raw water side turbidity is A (NTU) and raw water side total organic carbon content is B (mg/L).

5. The filtration method according to claim 1, wherein the measured value is the membrane filtration flux, and the permeate side negative pressure filtration is switched to the raw water side pressure filtration or the composite filtration when the measured value drops below a predetermined membrane filtration flux during constant flow rate filtration operation at the design flow rate via the permeate side negative pressure.

6. The filtration method according to claim 1, wherein the measured value is the suction lift of the permeate side corresponding to the transmembrane pressure, and
the permeate side negative pressure filtration is switched to the raw water side pressure filtration or the composite filtration when the suction lift of the permeate side has reached the available NPSH during constant flow rate filtration operation at the design flow rate via the permeate side negative pressure filtration.

7. The filtration method according to any of claim 1, wherein the abovementioned filtration operation is alternated with backwash operation, wherein
liquid runs through the membrane module from the permeate side to the raw water side with membrane air scrubbing being performed simultaneously.

8. The filtration method according to claim 7, wherein pressure is applied to the permeate side to perform backwash operation.

9. The filtration method according to claim 7, wherein negative pressure is applied to the raw water side to perform backwash operation.

10. The filtration method according to claim 7, wherein both positive pressure and negative pressure are applied to the permeate side and raw water side respectively to perform backwash operation.

11. The filtration method according to claim 7, wherein backwash may be performed by selectable means: applying positive pressure to the permeates side, applying negative pressure to the raw water side, or employing a combination of applying positive pressure to the permeates side and applying negative pressure to the raw water side.

12. A membrane filtration apparatus provided with membrane modules using pressure as a driving force, comprising:
a first means for regulating the raw water side pressure of membrane modules;
a second means for regulating the permeate side pressure of the membrane modules;
a measuring means for measuring the water quality of the raw water side of the membrane modules;
and a controlling means for controlling at least one of the first pressure regulation means and the second pressure regulation means based on values measured by the said measuring means, wherein
mode switching takes place among three modes: raw water side pressure filtration, permeate side negative pressure filtration and composite filtration combining the raw water side pressure filtration and the permeate side negative pressure filtration.

13. The membrane filtration apparatus according to claim 12, wherein the second pressure regulation means is a vacuum pump, and the measuring means is at least a turbidimeter and a TOC analyzer.

14. The membrane filtration apparatus according to either claim 12, wherein the controlling means selectively performs backwash by controlling at least one of the means that regulate the pressures on both the raw water and permeate sides, in order to perform backwash using the positive pressure on the permeate side, the negative pressure on the raw water side, or a combination of both pressures.
